(19) United States
(12) Patent Application Publication
(10) Pub. No.: US 2005/0264476 A1
(43) Pub. Date: Dec. 1, 2005

(54) Plasma display device and driving method of plasma display panel

(76) Inventors: Duck-Hyun Kim, Suwon-si (KR); Jin-Sung Kim, Suwon-si (KR)

Correspondence Address: Robert E. Bushnell, Suite 300, 1522 K Street, N.W., Washington, DC, 20005-1202, US

(21) Appl. No.: 11/121,090

(22) Filed: May 4, 2005

(30) Foreign Application Priority Data
May 25, 2004 (KR) 10-2004-0037308

(51) Int. Cl. G09G 3/28

(52) U.S. Cl. 345/60

(57) ABSTRACT

In a reset period of a subfield of a subfield group, a load ratio is calculated in correspondence with an input video signal, and then a gradually increasing voltage is applied to a scan electrode during a first period. The gradually increasing voltage increases from a first voltage to a second voltage in correspondence with the load ratio. A third voltage is applied during a second period after the application of the gradually increasing voltage. The first period and the second period are varied depending on the load ratio.

### CLAIM OF PRIORITY

This application makes reference to, incorporates the same herein, and claims all benefits accruing under 35 U.S.C. §119 from an application for PLASMA DISPLAY DEVICE AND DRIVING METHOD OF PLASMA DISPLAY PANEL earlier filed in the Korean Intellectual Property Office on 25 May 2005 and there duly assigned Serial No. 10-2004-0037308.

### BACKGROUND OF THE INVENTION

1. Technical Field

The present invention relates to a driving method of a plasma display panel (PDP) and a plasma display device. In particular, the invention relates to a driving method of a PDP wherein, when an image is realized based on an input of a phase alternation line (PAL) video signal of 50 Hz, a reset duration is varied according to an idle period included in a frame, thereby stabilizing a reset discharge after the idle period, such that misfiring is reduced in subsequent address and sustain discharges.

2. Related Art

A PDP has a plurality of discharge cells arranged in a matrix format, and visualizes image data input as an electric signal by selectively discharging the cells.

According to Korean Patent Publication No. 10-2000-0053573, which discloses a driving method of a PDP, at least in one predetermined subfield out of the plurality of subfields, at least a part of a sustain operation in the sustain period in the subfield, and at least a part of a reset operation in the reset period in a subsequent subfield, are simultaneously carried out. In addition, after simultaneous carrying out of at least a part of the sustain operation in the subfield and at least a part of the reset operation in a subsequent subfield, the reset operation of a reset period is carried out by a falling ramp voltage. The reset operation carried out by a rising ramp voltage in at least one predetermined subfield is called a main reset, and the reset operation carried out by a falling ramp voltage in at least one predetermined subfield is called an auxiliary reset.

According to such a method, in subfields subsequent to a second subfield, an initialization discharge may be produced only at a discharge cell displayed in an immediately previous subfield, and the initialization discharge may be prevented at a discharge cell that is not displayed in the immediately previous subfield.

In addition, driving time may be substantially reduced in comparison with other methods, since the time required for the reset period is substantially reduced and the time for an erase operation is not required.

However, with respect to performance of a main reset operation after an idle period positioned foremost in a subfield group according to the driving method of a PDP realizing an image of a PAL video signal, when the idle period is long, priming particles formed by a previous discharge are reduced, and accordingly the reset operation becomes unstable. This may cause misfiring in subsequent address and/or sustain periods.

The information disclosed in this section is only for enhancement of understanding of the background of the invention, and therefore, unless explicitly described to the contrary, it should not be taken as an acknowledgment, or any form of suggestion, that this information forms the prior art that is already known in this country to a person of ordinary skill in the art.

### SUMMARY OF THE INVENTION

The present invention has been developed in an effort to provide a driving method of a plasma display panel having the advantage of stable reset discharge by increasing a reset duration when an idle period is long.

An exemplary driving method of a plasma display panel is used for a plasma display panel that realizes grayscales by combining brightness weights of a plurality of subfields divided from an image of a frame displayed on the plasma display panel in response to an input video signal, wherein the plurality of subfields comprises at least two consecutive first and second subfield groups, each subfield of the at least two subfield groups comprising a reset period, an address period, and a sustain period.

According to such a driving method, in a reset period of at least one subfield of the subfield groups, a load ratio is calculated in correspondence to the video signal. A gradually increasing voltage is applied to a scan electrode during a first period, wherein the gradually increasing voltage increases from a first voltage to a second voltage in correspondence with a load ratio. A third voltage is applied during a second period after the application of the gradually increasing voltage. The first period and the second period are varied depending on the load ratio.

An exemplary plasma display device according to an embodiment of the present invention includes a plasma display panel and a driving circuit. The plasma display panel has a plurality of first electrodes, a plurality of second electrodes, and a plurality of third electrodes formed in a direction crossing the first and second electrodes. The driving circuit drives the plasma display panel in response to an input video signal by frames having at least two subfield groups and outputting a driving signal to the first, second and third electrodes in reset, address, and sustain periods. In a reset period of at least one subfield of the subfield group, the driving circuit applies a gradually increasing voltage to a scan electrode during a first period, the gradually increasing voltage increasing from a first voltage to a second voltage in correspondence with the load ratio of the input video signal, and the driving circuit then maintains supply of the second voltage for a second period. The first period and the second period are varied depending on the load ratio.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially cutaway perspective view of an alternating current (AC) plasma display panel (PDP).

FIG. 2 illustrates an electrode arrangement diagram of a PDP.

FIG. 3 illustrates a subfield arrangement.

FIG. 4 illustrates a subfield arrangement obtained by changing locations of idle periods in the subfield arrangement shown in FIG. 3.

FIG. 5 illustrates a driving waveform diagram of a PDP according to a driving method.

FIG. 6 illustrates a schematic layout of a plasma display device according to an embodiment of the present invention.

FIG. 7A and FIG. 7B illustrate a subfield arrangement according to the idle periods in a subfield scheme shown in FIG. 4, wherein FIG. 7A relates to the case of short idle periods and FIG. 7B relates to the case of long idle periods.

FIG. 8 illustrates a driving waveform of a PDP according to a first embodiment of the present invention.

FIG. 9 illustrates a driving waveform of a PDP according to a second embodiment of the present invention.

### DETAILED DESCRIPTION OF THE INVENTION

In the following detailed description, only certain exemplary embodiments of the present invention have been shown and described, simply by way of illustration. As those skilled in the art will realize, the described embodiments may be modified in various different ways, all without departing from the spirit or scope of the present invention. Accordingly, the drawings and description are to be regarded as illustrative in nature, and not restrictive. Like reference numerals designate like elements throughout.

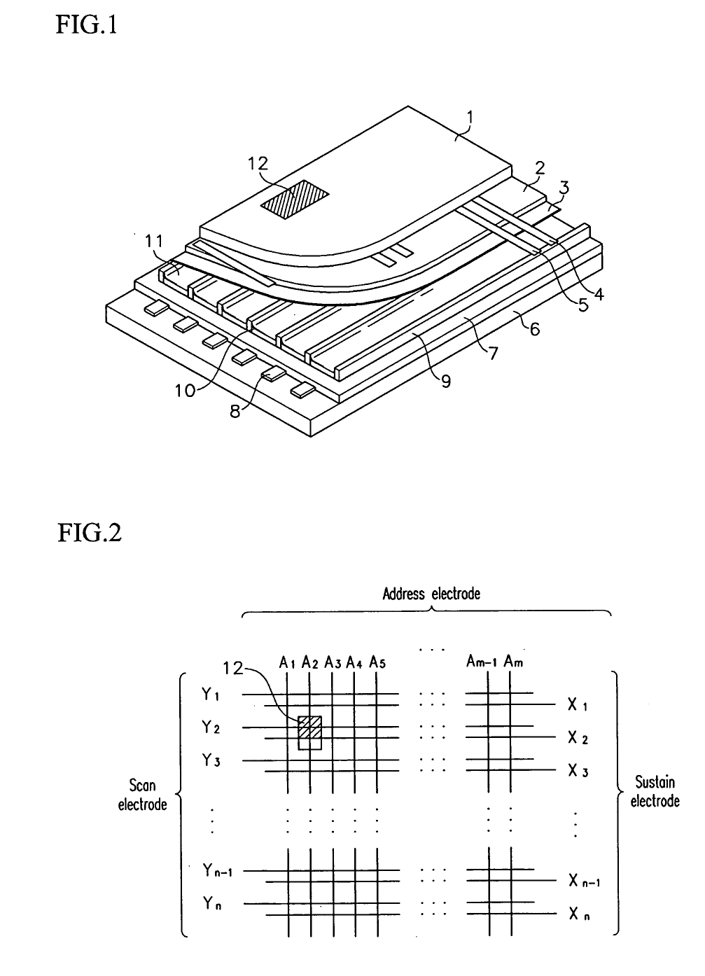

FIG. 1 is a partially cutaway perspective view of an alternating current (AC) plasma display panel (PDP).

As shown in FIG. 1, scan electrodes 4 and sustain electrodes 5 covered with a dielectric layer 2 and a protective layer 3 are arranged by pairs in parallel on a glass substrate 1. A plurality of address electrodes 8 covered with an insulator layer 7 are formed on a glass substrate 6. On the insulator layer 7, barrier ribs 9 are formed between the address electrodes 8 and in parallel therewith. In addition, phosphor 10 is formed on a surface of the insulation layer 7 and on both sides of the barrier ribs 8. The glass substrates 1 and 6 are arranged facing each other with a discharge space 11 therebetween such that the scan electrodes 4 and the sustain electrodes 5 lie perpendicular to the address electrodes 8. A discharge cell 12 is formed by a discharge space formed at an intersection region of an address electrode 8 and a pair of scan and sustain electrodes 4 and 5, respectively.

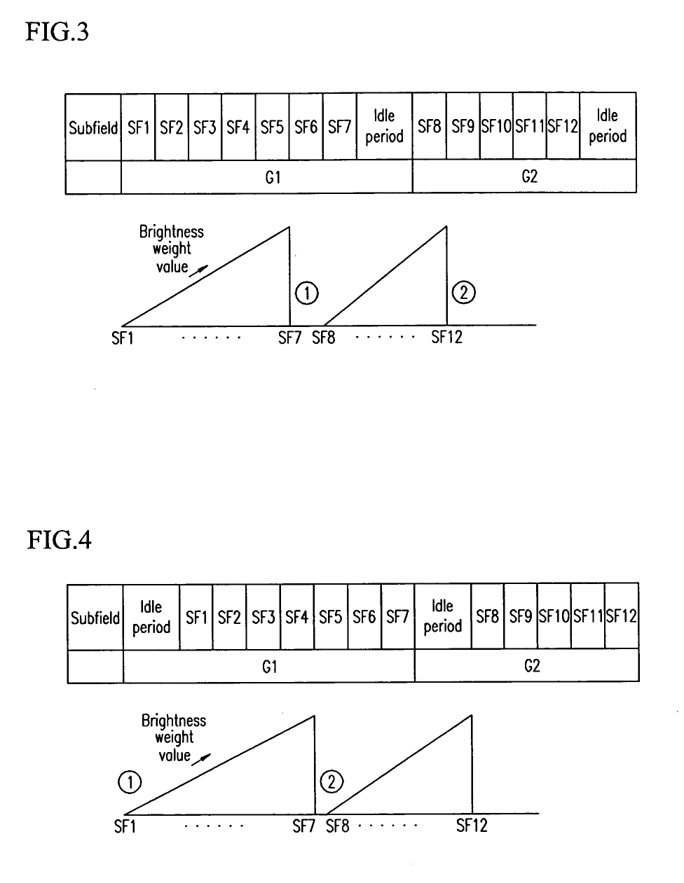

FIG. 2 illustrates an electrode arrangement diagram of a PDP, and FIG. 3 illustrates a subfield arrangement.

As shown in FIG. 2, electrodes of a PDP are arranged in an m×n matrix format. In more detail, address electrodes A₁-Aₘ are arranged in a column direction, and scan electrodes Y₁-Yₙ and sustain electrodes X₁-Xₙ are alternately arranged in a row direction.

Generally, the driving method of such an AC PDP may be expressed as operational changes according to time, which include a reset period, an address period, and a sustain period.

The reset period is for the purpose of initializing the state of each discharge cell so as to facilitate an addressing operation with respect to the discharge cell. The address period is for the purpose of selecting turn-on/turn-off cells (i.e., cells to be turned on or off) and accumulating wall charge relative to the turn-on cells (i.e., addressed cells). The sustain period is for the purpose of causing a discharge for displaying an image with the addressed cells.

Such a PDP should be able to display grayscales so that they can display colors. For a gradation display, a method has been used in which one field is divided into a plurality of sub-fields, and the sub-fields are controlled in a time-sharing manner.

Flicker is closely related to the visual characteristics of the human eye, and in general, flickers are more perceptible as the screen becomes bigger or the frequency lowers.

The case of realizing images of PAL video signals with the PDP satisfies the above-noted two conditions so as to cause a lot of flickers.

Therefore, when the PDP is driven at 50 Hz by using a minimum increment arrangement or a minimum decrement arrangement, which is a general arrangement of subfields used for the PDP, a lot of flickers are generated.

Since screen size cannot be controlled in the above-noted two conditions that cause flicker, a method for controlling the frequency is used to reduce the flicker.

Korean Patent Publication No. 10-2000-0016955 discloses a method for reducing flicker generation by control of the frequency. In order to reduce large screen flickers generated when inputting 50 Hz video signals and driving a PDP, subfields in a single frame are divided into two groups G1 and G2, and the subfields of the groups, except for the LSB (least significant bit) subfield, are established to have the same configuration, or luminance weights are similarly allocated to the subfields of the respective groups, as shown in FIG. 3. The above-described method is much more effective than other subfield arrangements, such as the minimum incremental arrangement or the minimum decrement arrangement.

Referring to FIG. 1, the subfields of a single frame are divided into two groups, and two idle periods are provided, one idle period being positioned at the end of the frame, that is, at the end of the second group G2, and another idle period being positioned between the two groups G1 and G2, that is, at the end of the first group G1.

However, the positions of the idle periods may be changed according to where a reference point for the frame having the two idle periods is put. For example, the idle periods \mathring{1} and \mathring{2} may be respectively positioned foremost in the groups G1 and G2, in contrast to the subfield arrangement shown in FIG. 3.

FIG. 4 illustrates such a subfield arrangement obtained by changing locations of idle periods in the subfield arrangement shown in FIG. 3.

Referring to FIG. 4, two idle periods are included in a single frame having two groups, and they are respectively positioned foremost in first and second groups G1 and G2.

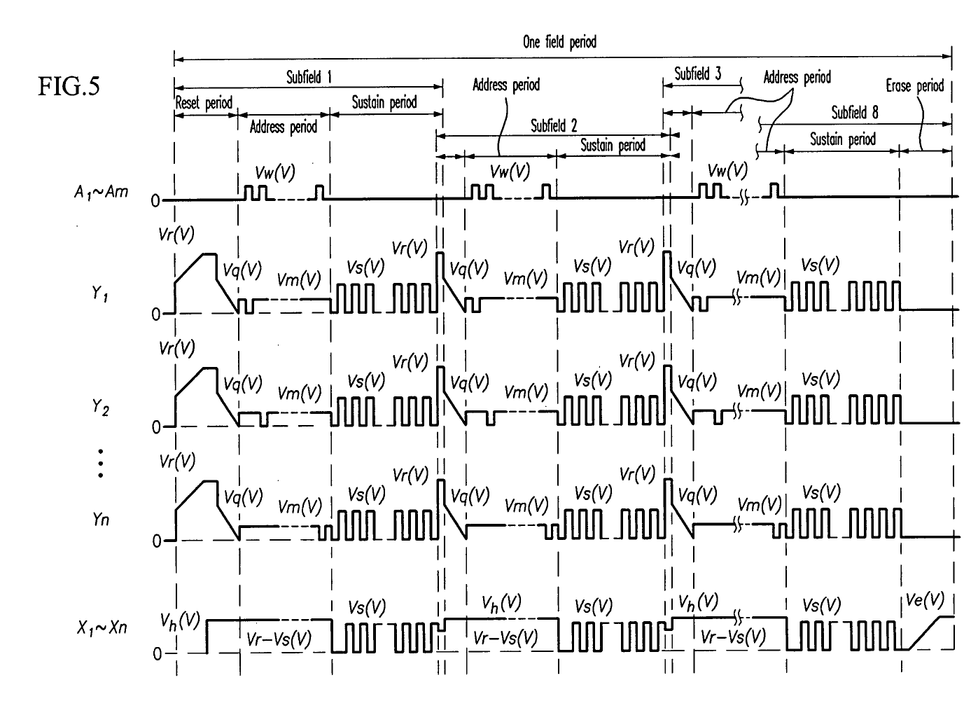

FIG. 5 illustrates a driving waveform diagram of a PDP according to a driving method. In particular, a driving method of a PDP will now be described in detail with reference to FIG. 5. More specifically, the driving method will be described in connection with the case of a PDP realizing an image of the above-mentioned PAL video signal.

As shown in FIG. 5, according to the driving method, in a subfield arrangement in which one frame is divided into fourteen subfields and the subfields are divided into two groups, each subfield includes a reset period, an address period, and a sustain period.

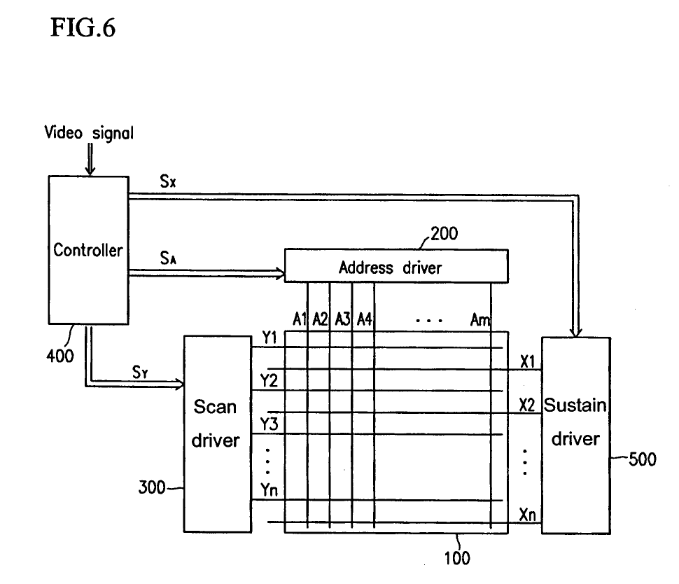

Hereinafter, the layout and operation of a plasma display device according to an embodiment of the present invention will be described in detail with reference to FIG. 6, which illustrates a schematic layout of a plasma display device according to an embodiment of the present invention.

As shown in FIG. 6, a plasma display device according to an embodiment of the present invention includes a plasma panel 100, an address driver 200, a scan driver 300, a controller 400, and a sustain driver 500.

The plasma panel 100 includes a plurality of address electrode A₁-Aₘ elongated in a column direction, and a plurality of scan and sustain electrodes Y₁-Yₙ and X₁-Xₙ, respectively, elongated in a row direction. The address buffer board 100 receives an address driving control signal SA from the controller 400, and applies a voltage for selecting turn-on discharge cells (i.e., discharge cells to be turned on) to address electrodes A₁-Aₘ.

The scan driver 300 and sustain driver 500 receive a scan electrode driving signal SY and a sustain electrode driving signal SX, respectively, from the controller 400, and apply them to the scan electrode Y₁-Yₙ and the sustain electrode X₁-Xₙ, respectively.

The controller 400, externally receiving video signals, generates the address driving control signal SA, the scan electrode driving signal SY, and the sustain electrode driving signal SX, and applies them to the address driver 200, the scan driver 300, and the sustain driver 500, respectively

In particular, according to an embodiment of the present invention, controller 400 divides a plurality of subfields included in a frame for realizing an image of a PAL video signal into at least two groups. The controller 400 generates a control signal to vary a reset duration of a reset waveform applied in correspondence to a load ratio of an input PAL video signal in a reset period in a foremost subfield in each group, and transmits the generated control signal to the scan driver 300.

Hereinafter, a driving method of a plasma display panel according to an embodiment of the present invention will be described in detail with reference to the drawings.

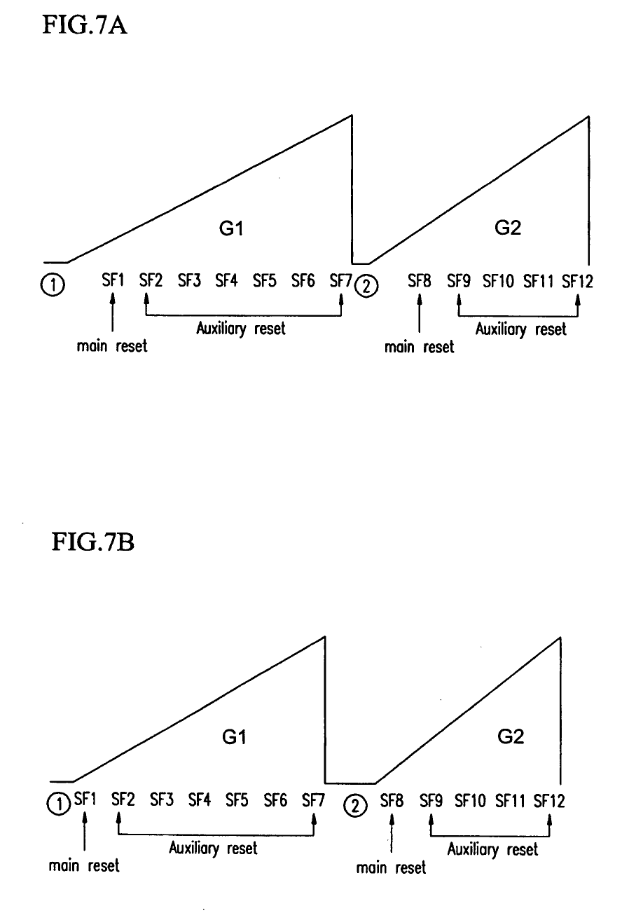

FIG. 7A and FIG. 7B illustrate a subfield arrangement according to the idle periods in a subfield scheme shown in FIG. 4, wherein FIG. 7A relates to the case of short idle periods and FIG. 7B relates to the case of long idle periods.

As shown in FIG. 7A and FIG. 7B, subfields according to an embodiment of the present invention are divided into two separate subfield groups G1 and G2. In addition, two idle periods are included in the subfield arrangement. That is, an idle period \mathring{1} of a first group G1 and an idle period \mathring{2} of a second group G2 are positioned foremost in subfield groups G1 and G2, respectively.

According to an embodiment of the present invention, the two separate subfield groups G1 and G2 include seven subfields SF1-SF7 and five subfields SF8-SF12, respectively. Brightness weight values of each subfield group are designed to gradually increase from lower to higher subfields. However, such a design may be altered by a person of ordinary skill in the art when put into a practical use.

On the other hand, since power consumption of a PDP is of a high level according to its driving characteristics, an automatic power control (APC) method, in which the power consumption is controlled based on a load ratio of a display frame or an average signal level, is usually adopted. According to such an APC method, the APC level is varied depending on the load ratio of input image data, and the number of sustain pulses is controlled in correspondence to respective APC levels such that the power consumption may remain below a predetermined level.

According to such an APC method, the number of sustain pulses applied in respective subfields changes according to the load ratio. That is, the total number of sustain pulses applied in the groups G1 and G2 is changed according to the load ratio, and therefore, the number of sustain pulses applied in each subfield is also changed according thereto since each subfield has sustain pulses in a number corresponding to the brightness weight value assigned to the subfield.

As described above, in the APC method, the number of sustain pulses is decreased according to predetermined APC levels as the load ratio increases such that an excessive increase in power consumption may be prevented. On the other hand, the idle period is varied according to the load ratio, and the idle period becomes longer as the load ratio increases.

Since the idle period is varied according to the load ratio as described with reference to FIG. 7A and FIG. 7B, starting points of the two subfield groups G1 and G2 divided from one frame may also be varied.

On the other hand, according to another driving method of a plasma display panel, the reset operation period remains the same regardless of the idle period. In a plasma display panel, priming particles and wall charge formed by a discharge operation are eliminated as time progresses from the discharge operation. Therefore, when the idle period is longer, such elimination thereof may become substantial so that a reset discharge may become difficult to generate after the idle period. For example, when the idle period \mathring{2} between the subfield groups G1 and G2 (shown in FIG. 7A) is lengthened, the reset discharge becomes difficult to generate in a reset period in a foremost subfield of the subfield group G2. In addition, when the idle period \mathring{1} between the last subfield group in a previous frame (not shown in FIG. 7A) and the subfield group G1 (shown in FIG. 7A) is lengthened, the reset discharge becomes difficult to generate in a reset period in a foremost subfield of the subfield group G1. That is, when an idle period lies between subfield groups in the same frame, or between a frame and a subsequent frame (e.g., between a rearmost subfield group of a previous frame and a foremost subfield group of a current frame), the reset discharge becomes difficult to generate in the reset period of a subsequent subfield because of elimination of wall charge and priming particles.

Therefore, according to an embodiment of the present invention, the driving waveform of a plasma display panel is proposed to provide more stability of the reset discharge by varying the reset duration of a reset period according to an idle period varied based on a load ratio. In particular, more stability of the reset discharge is obtained by further increasing the reset duration of the reset period for a long idle period.

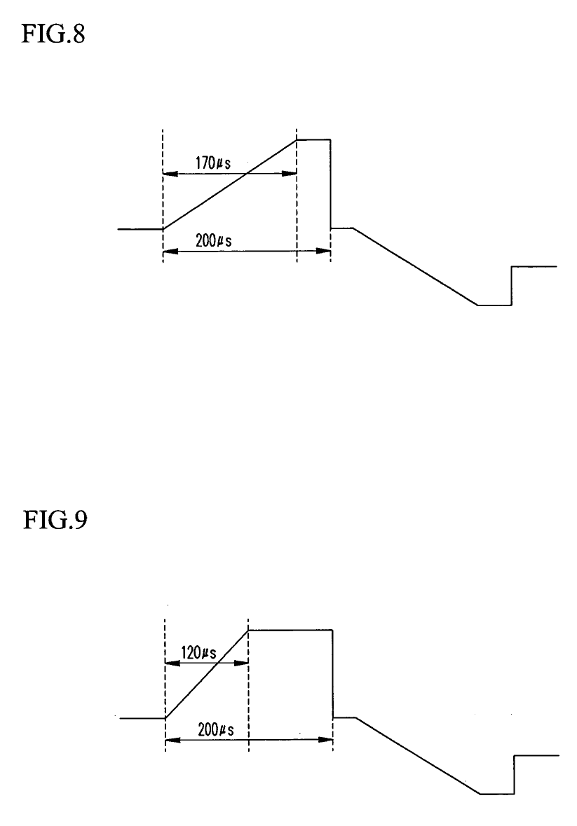

FIG. 8 and FIG. 9 illustrate driving waveforms of a PDP according to first and second embodiments, respectively, of the present invention.

As shown in FIG. 8 and FIG. 9, in a driving method of a plasma display panel according to an embodiment of the present invention, the reset operation period of the reset period is varied according to the idle period.

According to other driving methods of a plasma display panel, the period for the reset operation is the same regardless of the idle period. As discussed above, the reset discharge becomes more unstable as the idle period is lengthened because elimination of wall charge and priming particles becomes more substantial as the idle period gets longer. However, according to an embodiment of the present invention, when the idle period is longer, the reset duration is provided more sufficiently than in other reset operation periods so that stable reset discharge may be realized.

Referring to FIG. 8, according to a first embodiment of the present invention, the total reset operation period and the duration of a ramp waveform is increased in contrast to other reset driving waveforms in order to stabilize the reset discharge. For example, in the case wherein the total reset operation period, including a rising ramp period, is usually about 150 μs, and the duration of the rising ramp period is usually about 120 μs, the total reset operation period is increased to about 200 μs and, in particular, the duration of the rising ramp period is increased to about 170 μs. Then, a weak discharge in the discharge cell is maintained longer than in other methods, and accordingly, the state of the discharge cell becomes more stable.

In addition, referring to FIG. 9, according to a second embodiment of the present invention, the total reset period is increased to 200 μs, which is the same as in the first embodiment of the present invention. However, the rising ramp period is not increased, but only a period wherein a voltage Vset is applied after an end of the rising ramp period is increased. Therefore, the state of the discharge cell which experiences a weak discharge due to the ramp reset operation may be controlled so as to be more stable, and thus, the reset discharge of the reset period becomes stable against a long idle period.

As described above, the driving waveform of a plasma display panel, in particular, the waveform for a reset operation in a subfield subsequent to an idle period, is varied in accordance with the idle period. Therefore, the reset period becomes stabilized, and misfiring is accordingly reduced in subsequent address and sustain discharges.

Although a specific example of variation of the reset operation period in an embodiment of the present invention has been shown and described, it should be understood that the total operation period and ramp operation duration may be changed within the spirit and scope of the present invention.

As described above, according to an embodiment of the present invention, in the subfield arrangement structure of a PAL mode, the period of a reset waveform for a reset discharge is increased when the idle period is long, and a reset discharge after the idle period is accordingly stabilized, thereby reducing misfiring in subsequent address and sustain discharges.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A driving method of a plasma display panel which realizes grayscales by combining brightness weights of a plurality of subfields divided from an image of a frame displayed on the plasma display panel in response to an input video signal, the plurality of subfields comprising at least two subfield groups, each subfield of said at least two subfield groups comprising a reset period, an address period, and a sustain period;
the driving method, in a reset period of at least one subfield of said at least two subfield groups, comprising the steps of:
calculating a load ratio corresponding to the video signal;
applying a gradually increasing voltage to a scan electrode during a first period, the gradually increasing voltage increasing from a first voltage to a second voltage in correspondence with the load ratio; and
applying a third voltage during a second period after applying the gradually increasing voltage, wherein the first period and the second period are varied depending on the load ratio.

2. The driving method of claim 1, wherein an idle period preceding said at least two subfield groups is varied depending on the load ratio.

3. The driving method of claim 2, wherein the idle period becomes longer as the load ratio increases.

4. The driving method of claim 2, wherein the first period becomes longer as the idle period becomes longer.

5. The driving method of claim 2, wherein the second period becomes longer as the idle period becomes longer.

6. The driving method of claim 2, wherein the idle period is positioned between a first subfield group and a second subfield group of said at least two subfield groups.

7. The driving method of claim 2, wherein the idle period is positioned between a first subfield group and a previous subfield group of the first subfield group.

8. The driving method of claim 1, wherein the input video signal of the plasma display panel is a PAL video signal.

9. The driving method of claim 1, wherein the reset period of said at least one subfield is a reset period of a foremost subfield in each of said at least two subfield groups.

10. A plasma display device comprising:
a plasma display panel including a plurality of first electrodes and a plurality of second electrodes, and including a plurality of third electrodes formed in a direction crossing a direction of the first and second electrodes; and
a driving circuit for driving the plasma display panel in response to an input video signal by frames having at least two subfield groups, and for outputting a driving signal to the first, second, and third electrodes in reset, address and sustain periods;
wherein said driving circuit applies, in a reset period of at least one subfield of said at least two subfield groups, a gradually increasing voltage to a scan electrode during a first period, the gradually increasing voltage increasing from a first voltage to a second voltage in correspondence with a load ratio of the input video signal, and said driving circuit then maintains supplying of the second voltage for a second period; and
wherein the first period and the second period are varied depending on the load ratio.

11. The plasma display device of claim 10, wherein an idle period in a front of each of said at least two subfield groups becomes longer as the load ratio increases.

12. The plasma display device of claim 10, wherein an idle period in a rear of each of said at least two subfield groups becomes longer as the load ratio increases.

13. The plasma display device of claim 11, wherein the first period becomes longer as the load ratio increases.

14. The plasma display device of claim 11, wherein the second period becomes longer as the load ratio increases.

15. The plasma display device of claim 10, wherein the reset period comprises a reset period in a foremost subfield of each of said at least two subfield groups.

16. The plasma display device of claim 10, wherein the input video signal of the plasma display panel comprises a phase alternation line (PAL) video signal.
